(19) United States
(12) Patent Application Publication
(10) Pub. No.: US 2014/0006295 A1
(43) Pub. Date: Jan. 2, 2014

(54) DIGITAL CHAIN-OF-CUSTODY

(71) Applicant: Milwaukee Electric Tool Corporation, Brookfield, WI (US)

(72) Inventors: Jeffrey M. Zeiler, Pewaukee, WI (US); Leslie J. Reading, Lakeside, CA (US)

(21) Appl. No.: 13/931,355

(22) Filed: Jun. 28, 2013

Related U.S. Application Data
(60) Provisional application No. 61/666,340, filed on Jun. 29, 2012.

(51) Int. Cl. G06Q 30/00

(52) U.S. Cl. CPC G06Q 30/018
USPC 705/317

(57) ABSTRACT

A method and system for identifying and tracking ownership of a power tool, a power tool battery pack, or another device (“the device”) by storing a chain-of-custody in a memory therein. Initially, a serial number that uniquely identifies the device as well as first owner information, such as the manufacturer, are stored in the chain-of-custody memory. When ownership changes, such as when the device is received by a retailer, the chain-of-custody memory is updated to include the new (second) owner information. When the device is sold by the retailer, the ownership information is updated again to include the new (third) owner information. Reading and writing to the chain-of-custody memory may be performed wirelessly using an external wireless device, such as a handheld unit. Additionally, reading and writing to the chain-of-custody memory may occur via a secure transmission to avoid improper access to the memory.

### BACKGROUND

The present invention relates to electronic identifiers stored in commercial products.

### SUMMARY OF THE INVENTION

In one embodiment, the invention includes a power tool having a motor, a power supply module, a chain-of-custody memory, and a wireless transceiver. The motor drives an output unit and the power supply module supplies power to the motor. The chain-of-custody memory has stored thereon a serial number that uniquely identifies the power tool, first owner information indicating a previous owner of the power tool, and second owner information indicating a current owner of the power tool. The wireless transceiver is operable to communicate with an external wireless device by (a) sending, to the external wireless device, the serial number, the first owner information, and the second owner information in response to at least one read request, and (b) receiving, from the external wireless device, a write request including third owner information, which is stored in the chain-of-custody memory.

In another embodiment, the invention includes a power tool battery pack comprising: battery cells, a power tool interface, a chain-of-custody memory, and a wireless transceiver. The power tool interface is operable to be coupled to a power tool to provide power from the battery cells to the power tool and operable to be coupled to a charger to provide power from the charger to the battery cells. The chain-of-custody memory has stored thereon a serial number that uniquely identifies the power tool battery pack, first owner information indicating a previous owner of the power tool battery pack, and second owner information indicating a current owner of the power tool battery pack. The wireless transceiver is operable to communicate with an external wireless device by (a) sending, to the external wireless device, the serial number, the first owner information, and the second owner information in response to at least one read request, and (b) receiving, from the external wireless device, a write request including third owner information, which is stored in the chain-of-custody memory.

In another embodiment, the invention includes a method of identifying at least one of a power tool and a power tool battery pack having a chain-of-custody memory. The method includes reading, from the chain-of-custody memory, a serial number that uniquely identifies the at least one of a power tool and a power tool battery pack and reading, from the chain-of-custody memory, first owner information indicating a first owner of the at least one of a power tool and a power tool battery pack. The method further includes storing, in the chain-of-custody memory, second owner information indicating a second owner of the at least one of a power tool and a power tool battery pack, while retaining the serial number and the first owner information. The method also includes wirelessly transmitting, to an external wireless device, the serial number, the first owner information, and the second owner information in response to at least one read request and wirelessly receiving, from the external wireless device, a write request including third owner information indicating a third owner of the at least one of a power tool and a power tool battery pack. The method further includes storing, in the chain-of-custody memory, the third owner information while retaining the serial number, the first owner information, and the second owner information.

### BRIEF DESCRIPTION OF THE DRAWINGS

FIG. 1 illustrates a digital chain-of-custody system.

FIG. 2 illustrates a controller of a product of the digital chain-of-custody system of FIG. 1.

FIG. 3 illustrates a user interface of the product.

FIG. 4 illustrates the digital chain-of-custody system in operation.

FIG. 5 illustrates a handheld device of the digital chain-of-custody system of FIG. 1.

FIG. 6 illustrates a portal of the digital chain-of-custody system.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

It should also be noted that a plurality of hardware and software based devices, as well as a plurality of different structural components, may be used to implement the invention. In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium) executable by one or more processors. As such, it should be noted that a plurality of hardware and software based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible. For example, “controllers” described in the specification can include standard processing components, such as one or more processors, one or more computer-readable medium modules, one or more input/output interfaces, and various connections (e.g., a system bus) connecting the components. In some instances, the controllers described in the specification may be implemented in one of or a combination of a general processor, an application specific integrated circuit (ASIC), a digital signal processor (DSP), a field programmable gate array (FPGA), or the like.

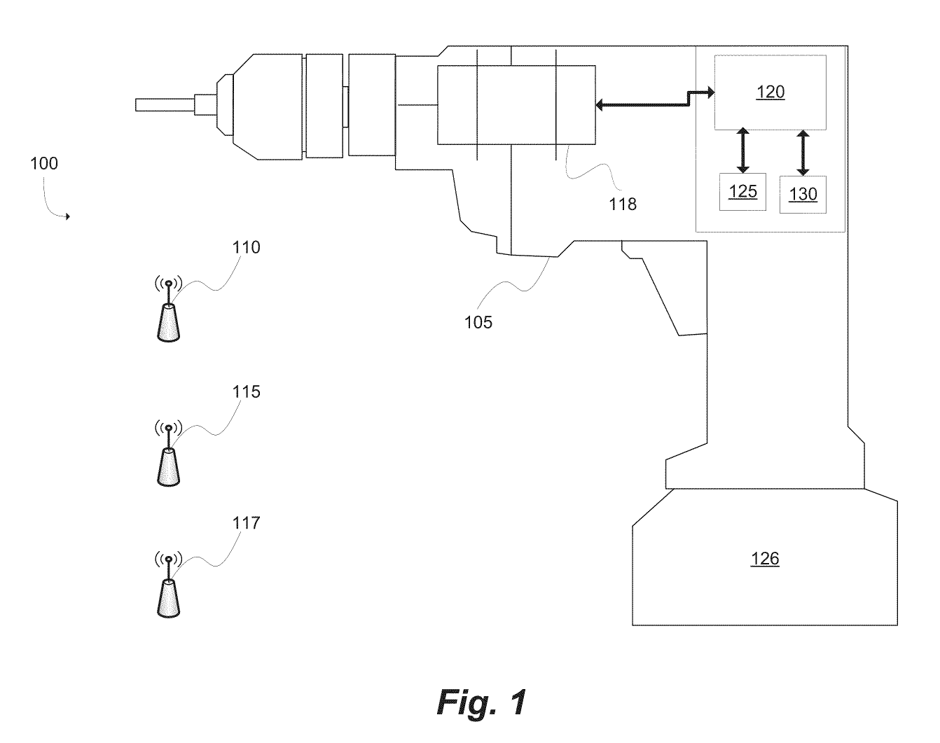

FIG. 1 illustrates a digital chain-of-custody system 100. The system 100 includes one or more products 105, a writer 110, and a reader 115. As illustrated, the product 105 is a power tool, such as a power drill. Although the product 105 is depicted as a power drill, other types of tools and accessories may also be used with the digital chain-of-custody system 100. For instance, the digital chain-of-custody system 100 may be used with battery packs, battery chargers, other power tools, test and measurement equipment, vacuum cleaners, work site radios, outdoor power equipment, and vehicles. Power tools can include drills, circular saws, jig saws, band saws, reciprocating saws, screw drivers, angle drivers, straight grinders, hammers, multi-tools, impact wrenches, rotary hammers, impact drivers, angle drills, pipe cutters, grease guns, and the like. Battery chargers can include wall chargers, multi-port chargers, travel chargers, and the like. Test and measurement equipment can include digital multimeters, clamp meters, fork meters, wall scanners, IR thermometers, laser distance meters, laser levels, remote displays, insulation testers, moisture meters, thermal imagers, inspection cameras, and the like. Vacuum cleaners can include stick vacuums, broom vacuums, and the like. Outdoor power equipment can include blowers, chain saws, edgers, hedge trimmers, lawn mowers, trimmers, and the like. The battery pack can also be attachable to and detachable from devices such as electronic key boxes, calculators, cellular phones, head phones, cameras, motion sensing alarms, flashlights, worklights, weather information display devices, a portable power source, a digital camera, a digital music player, a radio, and multi-purpose cutters. In some embodiments, the chain-of-custody components of the product 105 are included in unpowered products, such as paper products, cleaning solution, furniture, houseware, landscaping, building materials, etc. Additionally, the digital chain-of-custody system 100 is operable with multiple devices simultaneously.

The writer 110 is a radio-frequency identification (RFID) writer, or similar digital identification writer. The reader 115 is an RFID reader, or similar digital identification reader. In another embodiment the writer 110 and reader 115 are combined into one reader/writer 117. The wireless communications of the writer 110, reader 115, and reader/writer 117 may be Bluetooth, WiFi, Industrial, Scientific, and Medical (ISM) band (e.g., near 900 mHz), or other RFID communications.

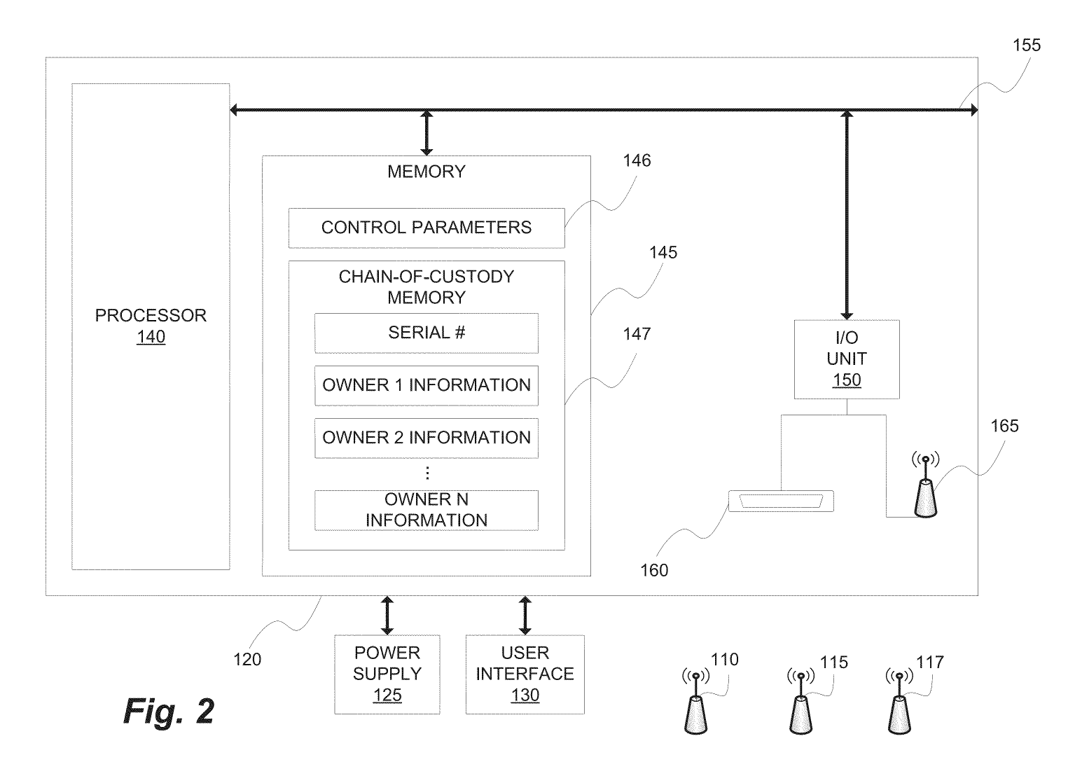

In one embodiment, the product 105 includes a motor 118, a controller 120, a power supply module 125, a battery pack 126, and a user interface 130. FIG. 2 illustrates the controller 120 of the product 105. The controller 120 is electrically and/or communicatively connected to a variety of modules or components of the chain-of-custody system 100. For example, the controller 120 is connected to the power supply module 125 and wirelessly connected to the writer 110, the reader 115, and/or the reader/writer 117. The controller 120 includes a plurality of electrical and electronic components that provide power, operational control, and protection to the components and modules within the controller 120. For example, the controller 120 includes, among other things, a processor 140 (e.g., a microprocessor, a microcontroller, or another suitable programmable device), a memory 145, and an input/output (JO) unit 150. The processor 140, memory 145, and I/O unit 150 are connected by one or more control and/or data buses (e.g., common bus 155). The control and/or data buses are shown generally in FIG. 2 for illustrative purposes. In some embodiments the controller 120 is implemented partially or entirely on a semiconductor (e.g., a field-programmable gate array [“FPGA”] semiconductor) chip.

The memory 145 includes, for example, a program storage area 146 (e.g., control parameter memory) and a data storage area 147 (e.g., chain-of-custody memory). The program storage area 146 and the data storage area 147 can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, hard disk, an SD card, or other suitable magnetic, optical, physical, or electronic memory devices. The data storage area 147, or chain-of-custody memory, includes information relative to the product 105. Chain-of-custody memory 147, for example, can include product serial number, current owner, past owner(s), owning dates, type of owner, store number, owner contact information, etc.

The processor 140 is connected to the memory 145 of the controller 120. Software stored on the memory 145 and executed by the processor 140 includes, for example, firmware, one or more applications, program data, filters, rules, one or more program modules, and other executable instructions. The controller 120 is configured to retrieve from memory 145 and execute, among other things, instructions related to the control processes and methods described herein. In other embodiments, the controller 120 includes additional, fewer, or different components for carrying out similar functionality described herein.

The power supply module 125 supplies DC voltage to the controller 120. The power supply module 125 is powered by, for example, one or more batteries or battery packs 126, or by an AC power source. The power supply module 125 is also configured to supply lower voltages to operate circuits and components within the controller 120. In other embodiments, the power supply module 125 is powered by an alternative power source (e.g., a generator, a solar panel, etc.).

In one embodiment, the battery pack 126 contains the components of the controller 140 to store information on chain-of-custody memory 147 contained within the battery pack 126 housing. In this embodiment, the battery pack 126 is the product 105 having a digital chain-of-custody. The battery pack 126 may further be usable as a power supply for another product 105.

The I/O unit 150 allows the controller 120 to communicate with the writer 110, reader 115, the reader/writer 117, and/or other similar components. The I/O unit 150 includes a wired port 160 and/or a wireless transmitter/receiver 165. The wired port 160 allows wired communication between the controller 120 and writer 110, reader 115, and/or the reader/writer 117. In some instances, the port 160 is implemented using the battery terminals of the product 105. For example, the writer 110, reader 115, and reader/writer 117 has a connecting portion that mirrors a footprint of a power tool battery, and data communication between the product 105 and the writer 110, reader 115, and/or reader/writer 117 via the battery terminals. The wireless transmitter/receiver 165 allows wireless communication between the controller 120 and writer 110, reader 115, and/or the reader/writer 117. In any example operation described below, the wired port 160 and wireless transmitter/receiver 165 may be used interchangeably.

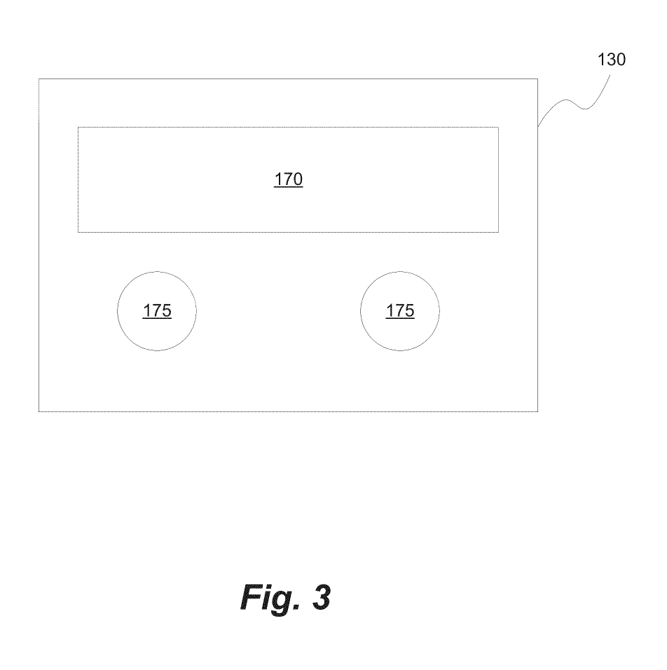

The user interface 130 is operably coupled to the controller 120. The user interface 130 includes a combination of digital and analog input or output devices required to achieve a desired level of control and monitoring. As shown in FIG. 3, for example, the user interface 130 includes a liquid-crystal display (LCD) 170, or similar display, and one or more push buttons 175. In other embodiments, the user interface 130 includes a speaker, a touch-screen display, a plurality of knobs, dials, switches, buttons, or any combination.

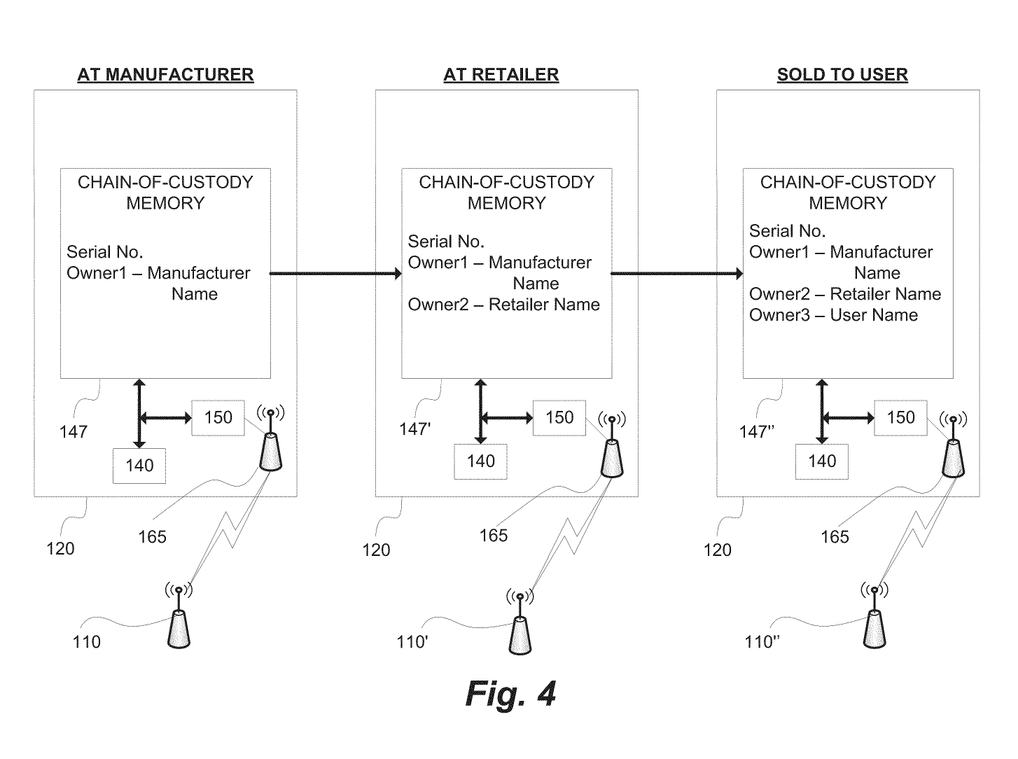

FIG. 4 illustrates an example implementation of a digital chain-of-custody using system 100 according to embodiments of the invention. In the example, when the product 105 is manufactured, a writer 110 communicates with the controller 120 via the wireless transmitter/receiver 165. The writer 110 communicates, for example, the serial number, owner1 information, and/or other information related to the product 105. The information is then stored in the chain-of-custody memory 147. The product 105 is then shipped to the retailer.

Once the product 105 is received by the retailer, a writer 110′ communicates with the controller 120 via the wireless transmitter/receiver 165. The writer 110′ communicates the information of the new owner (e.g., the retailer), as the owner2 information. The owner2 information is then stored in the chain-of-custody memory 147. When the owner2 information is stored in the chain-of-custody memory 147, the owner 1 information is not overwritten, or deleted, but is rather still available.

Thereafter, the product 105 may be sold by the retailer to a user. Once the product 105 is sold to a user, a writer 110″ communicates with the controller 120 via the wireless transmitter/receiver 165. The writer 110″ communicates the information of the new owner (e.g., the user), as the owner3 information. The owner3 information is then stored in the chain-of-custody memory 147. When the owner3 information is stored in the chain-of-custody memory 147 the owner1 information and the owner2 information are not overwritten, or deleted, but are rather still available. If the product 105 is ever resold by the user, a writer 110 can be used to communicate new owner information to the controller 120 and store the new owner information in the chain-of-custody memory 147 to supplement the earlier-stored owner information.

At any point after manufacture, the reader 115 can be used to read the chain-of-custody memory 147, including the serial number, current owner information, and past owner information. Further, at any time after manufacture the user interface 130 can be used to communicate the chain-of-custody memory 147 directly from the product 105 without the need of a reader 115. The user interface 130 can communicate the information by displaying the information on a screen, or by using a speaker to announce the information.

In another example operation, the digital chain-of-custody system 100 is used for temporary owners, such as daily check-outs at a work site, or rentals. In this example, a writer 110 is used to communicate information such as temporary name, date, etc. For example, a renter rents the product 105 from a rental supply store. A writer 110 is used to communicate with the controller 120 and update the chain-of-custody memory 147 with the renter's information, such as the renter's name, start time/date of rental, and end time/date of rental. In one embodiment the controller 120 shuts down the tool 105 upon the rental period expiring. In another embodiment, the controller 120 communicates a message via the user interface 130 alerting the renter that the rental period has expired.

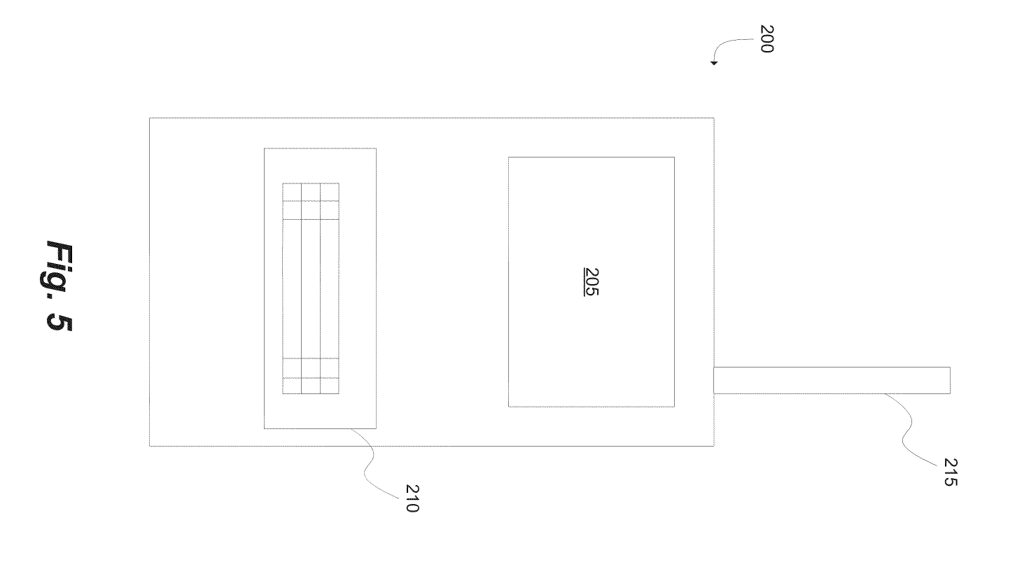

As shown in FIG. 5, in one embodiment the writer 110, reader 115, or reader/writer 117 is a handheld device 200. The handheld device 200 includes a screen 205, one or more push buttons 210, an antenna 215, and a device controller (not shown). The device controller further includes a device processor and a device memory. The device processor receives a signal from the product 105, via the antenna 215, or from the one or more push buttons 210. The device processor then executes a software program, stored in the device memory, for analyzing the signal, and generates one or more control signals to read or write the chain-of-custody memory 147 of the product 105.

In operation, using a reader/writer 117 as an example, the handheld device 200 communicates with the controller 120 of the product 105, via the antenna 215 and the wireless transmitter/receiver 165. The processor 140 of the controller 120 communicates the information stored on the chain-of-custody memory 147 to the handheld device 200. The chain-of-custody memory 147 is then displayed on the screen 205 of the handheld device 200. A user then manually enters new information, such as new owner information, using the one or more push buttons 210 of the handheld device 200. The handheld device 200 then communicates with the controller 120, via the antenna 215 and the wireless transmitter/receiver 165. The processor 140 stores the new information in the chain-of-custody memory 147.

In another embodiment, the information communicated by the writer 110 is preprogrammed and does not have to be manually entered. The writer 110 or reader/writer 117 has preprogrammed information to store on the chain-of-custody memory 147 of various products 105. In operation, rather than manually entering the new information and then transmitting the information to the product 105, preprogrammed information is transmitted to the product 105 automatically once the product 105 is within wireless communication range or after a user depresses a “write” button, or the like. This adds convenience in that the information does not have to be manually entered every time a new product 105 is received or sold by the retailer.

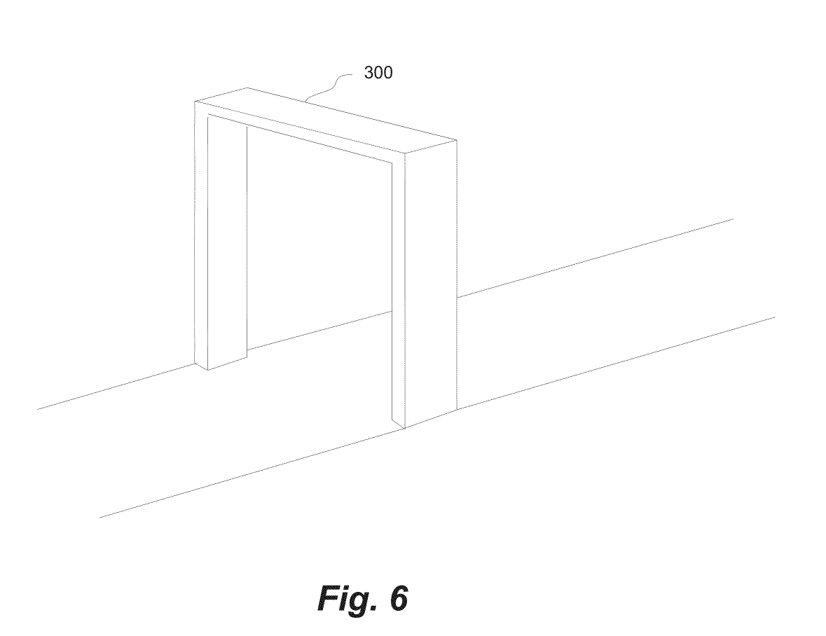

As shown in FIG. 6, in one embodiment the writer 110, reader 115, or reader/writer 117 is a portal 300. In one embodiment, a user walks through the portal 300 upon checkout. As the user walks through the portal 300, upon exiting the store for example, the writer 110 communicates the new owner information with the controller 120. The new owner information is then stored within the chain-of-custody memory 147. In some instances, the new owner information is generic information, not specific to the purchaser, to indicate that the retailer is no longer the owner. Accordingly, at the point-of-sale, specific new owner information need not be entered. In another embodiment, the portal 200 is used at the receiving dock of a retailer. When a product 105 is received by a retailer, the product 105 is brought in through the portal 300, thus storing the new owner information in the chain-of-custody memory 147.

In one embodiment, the writer 110, reader 115, or reader/writer 117, has security features. The security features include a security code being entered. Once a correct security code is entered the writer 110, reader 115, or reader/writer 117 will then have permission to read the chain-of-custody memory 147, or authority to write the chain-of-custody memory 147. For example, the security code may be checked against a security code stored in the reader/writer 117, product 105, or both, before read/write access is granted. The communications between the reader/writer 117 and product 105 may also be encrypted to provide additional security.

In one embodiment, if the product 105 is stolen from the retailer/manufacturer, without new owner information entered, the product 105 can be deactivated upon the product 105 passing through the portal 300. When the product 105 passes through the portal 300, the product 105 and portal 300 communicate in order for new information to be written in the chain-of-custody memory 147. If the portal 300 does not have new information, because new information was not entered by the retailer, the portal 300 will send a signal to the product 105 in order to prevent the product 105 from operating until new information, such as new owner information, is entered. Alternatively, the portal 300 may be coupled to a database of the retailer that indicates whether a particular product 105 has been purchased. For instance, the portal 300 may query a product 105 passing therethrough for its serial number. The portal 300 then queries the database with the serial number. The database returns a message indicating whether the product 105 has been purchased.

In yet another embodiment, the retailer may update owner information at a point-of-sale register, or the like, using the writer 110 or reader/writer 117. The portal 300 then reads the chain-of-custody memory 147 of all products 105 passing therethrough to determine if the products 105 exiting the retailer have updated owner information, which indicates that the product 105 has been properly purchased. If the product 105 has not been properly purchased, the portal 300 may send a communication to the controller 120 causing the product 105 to be deactivated. Further, when the product 105 has not been properly purchased and passes through the portal 300, the portal 300 notifies the retailer that the product 105 has not been properly purchased. The notification can be an alarm sounding at the location of the portal 300, an e-mail, an short message service (SMS) text, etc.

In another embodiment, the communications between the product 105 and the writer 110, reader 115, or reader/writer 117, such as for read and write operations, occur over a network. The network may include a local area network (LAN), wide area network (WAN), the Internet, a mesh network, a combination thereof, or another network configuration. For example, the network can comprise a main computer terminal and multiple access points. The owner information is entered at the main computer terminal, which acts as the writer 110, reader 115, or reader/writer 117. The owner information is sent over one or more access points of the network. The one or more access points then communicate with the products 105 wirelessly, updating the chain-of-custody memory 147. The main computer terminal can be located on-site with the products 105, or off-site at a remote location.

Thus, the invention provides, among other things, a digital chain-of-custody system for various products. Various features and advantages of the invention are set forth in the following claims.

What is claimed is:

1. A power tool comprising:
a motor for driving an output unit;
a power supply module that supplies power to the motor;
a chain-of-custody memory storing
a serial number that uniquely identifies the power tool,
first owner information indicating a previous owner of the power tool, and
second owner information indicating a current owner of the power tool; and
a wireless transceiver operable to communicate with an external wireless device, the wireless transceiver:
sending, to the external wireless device, the serial number, the first owner information, and the second owner information in response to at least one read request, and
receiving, from the external wireless device, a write request including third owner information, which is stored in the chain-of-custody memory.

2. The power tool of claim 1 further comprising a user interface including a display, the user interface, upon a user request, displays on the display at least one of the serial number, the first owner information, the second owner information, and the third owner information.

3. The power tool of claim 1 further comprising a user interface including a speaker, the user interface, upon a user request, conveys audibly via the speaker at least one of the serial number, the first owner information, the second owner information, and the third owner information.

4. A power tool battery pack comprising:
battery cells;
a power tool interface operable to be coupled to a power tool to provide power from the battery cells to the power tool and operable to be coupled to a charger to provide power from the charger to the battery cells;
a chain-of-custody memory storing
a serial number that uniquely identifies the power tool battery pack,
first owner information indicating a previous owner of the power tool battery pack, and
second owner information indicating a current owner of the power tool battery pack; and
a wireless transceiver operable to communicate with an external wireless device, the wireless transceiver:
sending, to the external wireless device, the serial number, the first owner information, and the second owner information in response to at least one read request, and
receiving, from the external wireless device, a write request including third owner information, which is stored in the chain-of-custody memory.

5. The power tool battery pack of claim 4 further comprising a user interface including a display, the user interface, upon a user request, displays on the display at least one of the serial number, the first owner information, the second owner information, and the third owner information.

6. The power tool battery pack of claim 4 further comprising a user interface including a speaker, the user interface, upon a user request, conveys audibly via the speaker at least one of the serial number, the first owner information, the second owner information, and the third owner information.

7. A method of identifying at least one of a power tool and a power tool battery pack having a chain-of-custody memory, comprising:
reading, from the chain-of-custody memory, a serial number that uniquely identifies the at least one of a power tool and a power tool battery pack;
reading, from the chain-of-custody memory, first owner information indicating a first owner of the at least one of a power tool and a power tool battery pack;
storing, in the chain-of-custody memory, second owner information indicating a second owner of the at least one of a power tool and a power tool battery pack, while retaining the serial number and the first owner information;
wirelessly transmitting, to an external wireless device, the serial number, the first owner information, and the second owner information in response to at least one read request;
wirelessly receiving, from the external wireless device, a write request including third owner information indicating a third owner of the at least one of a power tool and a power tool battery pack; and
storing, in the chain-of-custody memory, the third owner information while retaining the serial number, the first owner information, and the second owner information.

8. The method of claim 7 further comprising displaying at least one of the serial number, the first owner information, the second owner information, and the third owner information on a display of at least one of the external wireless device and the at least one of a power tool and a power tool battery pack.

9. The method of claim 7 further comprising audibly conveying at least one of the serial number, the first owner information, the second owner information, and the third owner information via a speaker of at least one of the external wireless device and the at least one of a power tool and a power tool battery pack.
